(19) United States
(12) Patent Application Publication
(10) Pub. No.: US 2016/0153555 A1
(43) Pub. Date: Jun. 2, 2016

(54) PIVOTING ASSEMBLY MOUNTED ON A MOTOR VEHICLE GEARBOX FOR SHIFTING AND SELECTING GEARS

(71) Applicant: DURA AUTOMOTIVE SYSTEMS SAS, Bievres (FR)

(72) Inventor: Sébastien Maitre, Monistrol-Sur-Loire (FR)

(21) Appl. No.: 14/896,947

(22) PCT Filed: Jun. 4, 2014
(86) PCT No.: PCT/FR2014/051333

§ 371 Date: Dec. 9, 2015

(30) Foreign Application Priority Data
Jun. 12, 2013 (FR) 1355415

(51) Int. Cl. F16H 61/36; F16H 61/24

(52) U.S. Cl. CPC F16H 61/36; F16H 61/24; F16H 2061/246

(57) ABSTRACT

The assembly is a pivoting assembly mounted on a shaft on a motor vehicle gearbox for shifting and selecting gears, said assembly being mounted to pivot on the gearbox and having two levers or bent arms and having at each free end arrangements for connecting cables or bars operated by a control lever mounted in the vehicle interior. The assembly includes, in combination, at least one mass and at least one component with the capacity to dampen and filter the vibrations, said component being positioned between the arrangements of coupling and pivoting shaft.

### CROSS-REFERENCE TO RELATED APPLICATIONS

This U.S. utility patent application is a national stage application under 35 U.S.C. §371 of international application PCT/FR2014/051333, filed Jun. 4, 2014, and claims the benefit of priority under 35 U.S.C. §119 of French Patent Application No. 1355415, filed Jun. 12, 2013, the entire contents of which are hereby incorporated herein by reference for all purposes.

### TECHNOLOGICAL FIELD

The present patent concerns the technical area of equipment for motor vehicles and more particularly, a gearbox control for shifting and selecting gears, in particular mechanical.

### BACKGROUND

In an embodiment well-known to the man of the art, the shifting and selection of gears is carried out by a lever assembled with a capability of angular movement and a support housing, generally attached to the interior compartment of the vehicle.

The lower end of the lever has arrangements for the selection and shifting of the gears, working in combination with transfer devices, generally a pivoting assembly mounted on a motor vehicle gearbox. This gear shifting and selecting assembly is generally mounted to pivot at the gearbox and includes two bent arms having arrangements for connecting to cables or bars, connected to the control lever.

According to the state of the art, this pivoting assembly for shifting and selection, has an inertia mass generally formed during the manufacture of said assembly. The purpose of this inertia mass is to facilitate and accompany shifting between gears.

The inertia mass is a monobloc assembly with the body of the assembly made to pivot, increasing the cost of manufacture. Furthermore, this mass is fixed in position. Refer to the illustrated example of FIG. 1.

It has also been observed that this inertia mass tends to increase the vibration which is, accordingly, transmitted directly to the control lever. To overcome this drawback, it has been proposed to fit the cable ends with a damping device, for instance, of rubber. This solution therefore means having a specifically designed cable end and it can be observed, in addition, that the effect of vibration reduction is not totally fulfilled.

### SUMMARY

The presently described embodiments are designed for overcoming these drawbacks in a simple, reliable, efficient and rational manner.

The problem that the described embodiments resolve is again that of providing the pivoting assembly with an inertia mass but of significantly decreasing the vibration by acting, not on the cable coupling, but rather on the said pivoting assembly for shifting and selecting gears.

To deal with this problem, the described embodiments concern a pivoting assembly mounted on a motor vehicle gearbox for shifting and selecting gears, said assembly comprising two levers or bent arms connected by cables or bars to in the vehicle interior compartment. According to the embodiments, the assembly includes, by combination, at least one mass and at least one component suitable for damping and filtering the vibrations.

The described embodiments therefore use the principle which is well known to the man of the art, of the mechanical mass/spring system acting as a vibration damper.

From this design, various embodiments can be envisioned.

In one embodiment, the mass and the element with the capacity to dampen the vibrations are superimposed and attached to one of the arms.

In this embodiment, the mass and the element with the capacity to dampen the vibrations are arranged coaxially or otherwise.

In another embodiment, the component with the capacity to dampen the vibration is mounted inside the mass in the form of a cylindrical housing.

In another embodiment, the component with the capacity to dampen the vibration is a ring.

In this embodiment, the ring can either be fitted with the mass and be attached to one of the bent arms or be attached at the pivoting shaft of the pivoting assembly with the mass attached independently to one of the arms.

### BRIEF DESCRIPTION OF THE FIGURES

The contemplated embodiments are described below in greater detail and illustrated by the attached figures in which:

FIG. 1 is a perspective view of one embodiment of the pivoting assembly according to a prior embodiment of the technique,

FIG. 2 is a partial sectional view of one form of embodiment,

FIG. 3 is a perspective view corresponding to FIG. 2,

FIGS. 4, 5 and 6 are perspective views corresponding to different embodiments in both the type of engineering and the positioning of the mass and the component with the capacity to dampen and filter the vibrations.

### DETAILED DESCRIPTION

For better understanding of the continuation of the description, note that the pivoting assembly (E) is mounted on a motor vehicle gearbox for shifting and selecting gears.

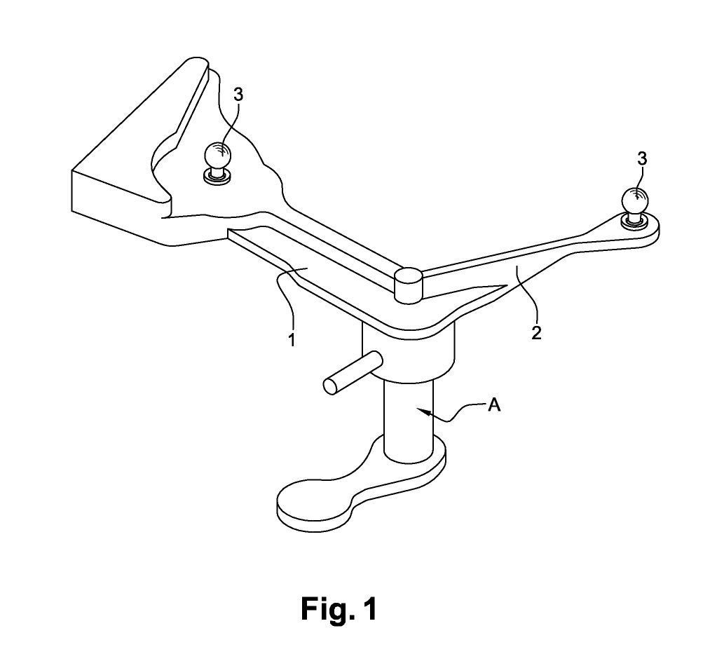

In a known manner and as illustrated by FIG. 1, this assembly is mounted to pivot on a gearbox, for instance, by means of a shaft (A).

This assembly (E) has two arms (1) and (2) which may, for instance, be bent. Again in a known manner, each arm generally has at each free end arrangements, for instance, in the form of swivels (3) for connecting cables or bars operated by a control lever mounted in the vehicle interior compartment for shifting and selecting gears This pivoting assembly (E) forming a transfer device can assume different shapes which are well known and used in the field of automobile vehicle gearboxes, especially mechanical gearboxes

According to the described embodiments, the swiveling assembly (E) includes by combination at least one mass (4) and at least one component (5) capable of damping and filtering the vibrations. From this basic design, the mass (4) and the component (5) can be manufactured in various embodiments and positioned on a part of the pivoting assembly (E) in various ways.

The mass (4) is made in terms of its volume and/or its component material, to generate a certain weight. As far as component (5) is concerned, it can be produced in any appropriate way, with the capacity to filter out the vibrations. For instance, component (5) is made of a rubbery material.

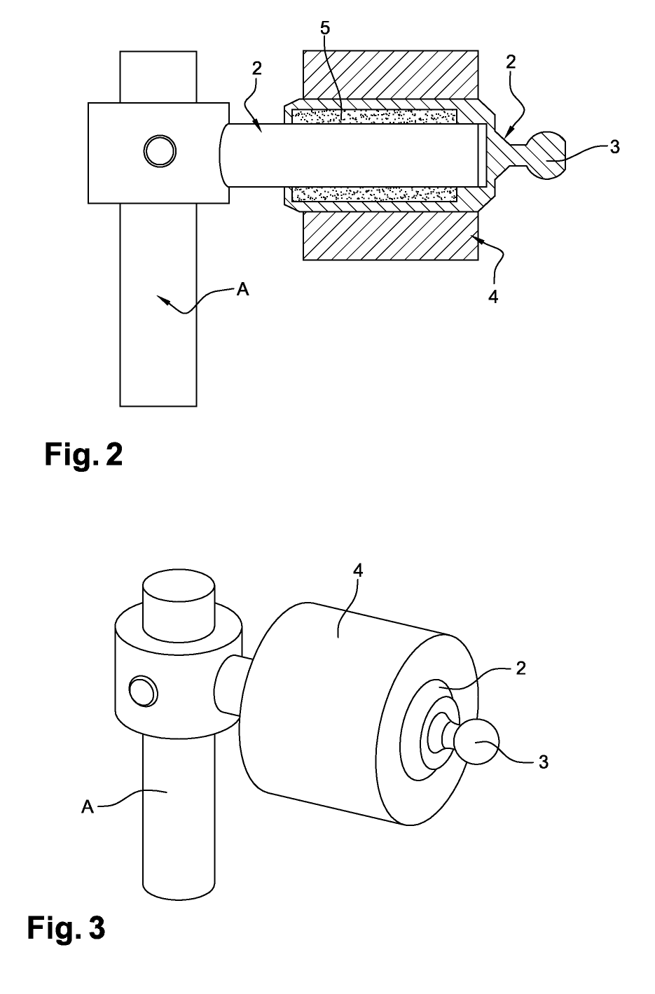

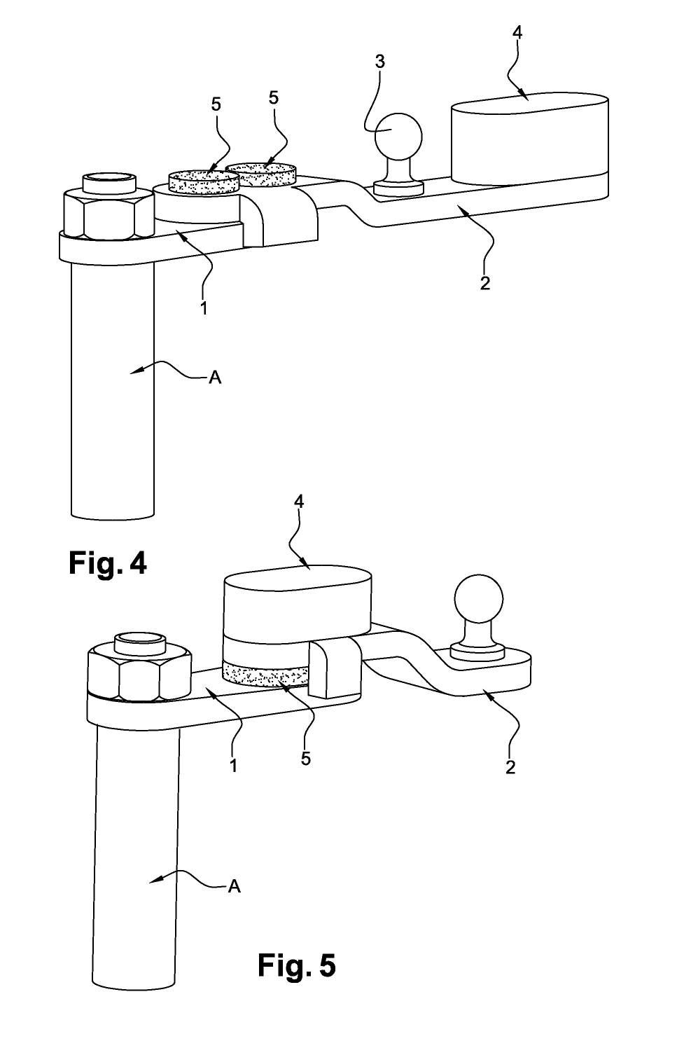

In the embodiment illustrated in FIGS. 2 and 3, the flexible component (5) is a cylindrical ring attached to the lever (2) for instance. In this case, the mass (4) consists of a cylindrical body engaged around the damping ring (5).

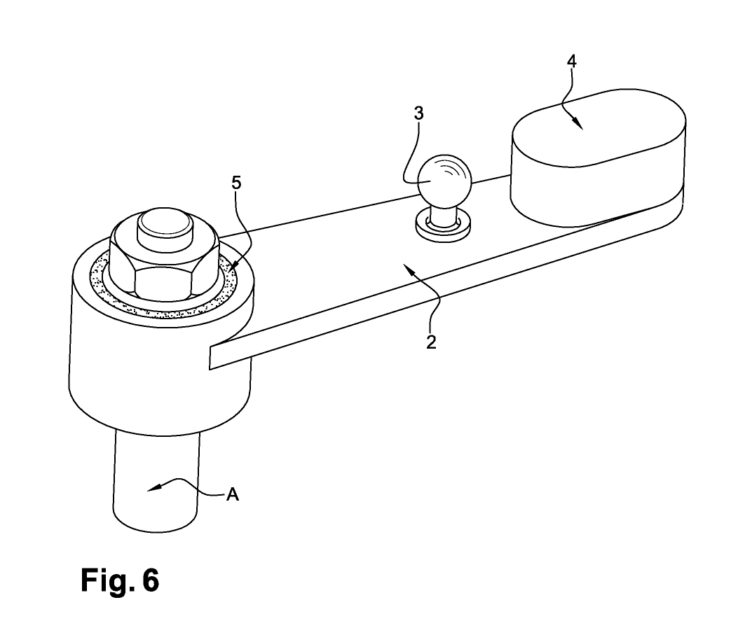

In the embodiment illustrated in FIG. 4, the mass (4) is mounted at the end of one of arms (1) or (2). In this case, the coupling arrangements (3) of the arm for the assembly of the cable or the bar, are placed upstream of the mass. In this embodiment, the vibrations are damped and filtered by two components (5) attached either to a lever, or each attached to an arm.

In FIG. 5, damping component (5) is attached to one of arms (1) while mass (4) is attached to the other arm (2) while being superimposed on said flexible component (5).

Finally, in FIG. 6, mass (4) is attached to the end of one of arms (1) or (2) in the same way as in the embodiment illustrated in FIG. 4). In this case, damping flexible component (5) appears as a ring attached to pivoting shaft (A) of the assembly forming the transfer device.

Advantages are evident from the description and in particular the following are underscored and referred to:

The efficiency of the obtained results.

The simplicity of the embodiment.

1. A pivoting assembly mounted on a shaft on a motor vehicle gearbox for shifting and selecting gears, said assembly being mounted to pivot on the gearbox and having two levers or bent arms having at each free end arrangements for connecting cables or bars operated by a control lever mounted in the vehicle interior, wherein said assembly includes, in combination, at least one mass and at least one component with the capacity to dampen and filter the vibrations, said component being positioned between the arrangements of coupling and pivoting shaft.

2. The assembly according to claim 1, wherein the mass and the component with the capacity to dampen and filter the vibrations, are superimposed and attached to one of the arms.

3. The assembly according to claim 1, wherein the mass and the component with the capacity to dampen and filter the vibrations are superimposed and attached to one of the arms.

4. The assembly according to claim 1, wherein the component with the capacity to dampen the vibration is mounted inside the mass in the form of a cylindrical housing.

5. The assembly according to claim 4, wherein the component with the capacity to dampen the vibrations is in the shape of a ring.

6. The assembly according to claim 4, wherein the ring receiving the mass is attached to one of the bent arms.

7. The assembly according to claim 6, wherein the ring is attached at a swiveling shaft of said assembly, with mass being attached to one of the bent arms.

8. The assembly according to claim 2, wherein the mass and the component with the capacity to dampen and filter the vibrations are superimposed and attached to one of the arms.

9. The assembly according to claim 5, wherein the ring receiving the mass is attached to one of the bent arms.

10. The assembly according to claim 9, wherein the ring is attached at a swiveling shaft of said assembly, with the mass being attached to one of the bent arms.
